(19) United States
(12) Patent Application Publication
(10) Pub. No.: US 2017/0017403 A1
(43) Pub. Date: Jan. 19, 2017

(54) STORAGE SYSTEM

(71) Applicant: HITACHI, LTD., Tokyo (JP)

(72) Inventors: Kenji SEKINE, Tokyo (JP); Yutaka WATANABE, Tokyo (JP); Atsushi MIYAGAKI, Tokyo (JP); Nobuhito MORI, Tokyo (JP); Tomohiro KAWAGUCHI, Tokyo (JP)

(21) Appl. No.: 15/124,130

(22) PCT Filed: Jun. 24, 2014
(86) PCT No.: PCT/JP2014/066654

§ 371 Date: Sep. 7, 2016

(51) Int. Cl. G06F 3/06

(52) U.S. Cl. CPC G06F 3/065; G06F 3/0619; G06F 3/0683

(57) ABSTRACT

A storage system creates an HA configuration in a virtual storage composed of resources of first and second storage subsystems. A user of the virtual storage selects a replication destination volume (second logical volume) of a first logical volume of the first storage subsystem that the user wishes to duplicate from the second storage. At this time, only a logical volume not recognized from a host is selectable as the second logical volume. When data duplication between the first logical volume and the second logical volume is started, the second storage subsystem sets an identification number of the second logical volume to be the same as the identification number of the first logical volume. Thereafter, at the point of time when duplication is completed, the second storage changes the setting of the second logical volume so that the second logical volume can be recognized from the host.

### TECHNICAL FIELD

The present invention relates to facilitating operation management of a system composed of multiple storage subsystems.

### BACKGROUND ART

Along with the rapid increase in the amount of electronic information handled in companies and other organizations, many storage subsystems are introduced and operated in the IT systems of organizations. One of the drawbacks of introducing a large number of storage subsystems in a computer system is that the management costs of the administrator of the computer system are increased. In order to facilitate management of multiple storage subsystems, a storage virtualization technique enabling multiple storages to be accessed virtually as a single storage is widely adopted.

As a prior art, a technique exists for composing a single virtual storage subsystem from multiple storage subsystems. In a single (virtual) storage subsystem, there is a need to assign a unique ID (called LDEV #) to each resource (such as each volume) within the subsystem, but when the single virtual storage subsystem is composed of two physical storage subsystems, LDEVs having the same LDEV # exist in each of the two physical storage subsystems, and the two LDEVs cannot be distinguished from a host or other superior devices. Patent Literature 1 discloses an art where each LDEV in a storage subsystem is configured to have a local ID, which is an ID unique within the physical subsystem, and a global ID, which is an ID unique within the virtual storage, wherein when a single virtual storage subsystem is constructed from storage subsystem A and storage subsystem B, the global ID assigned to each LDEV of the storage subsystem B is re-assigned to an ID that does not overlap with the global ID assigned to the respective LDEVs of storage subsystem A.

### CITATION LIST

### Patent Literature

### [PTL 1] Japanese Patent Application Laid-Open Publication No. 2008-040571

### SUMMARY OF INVENTION

### Technical Problem

In a system required to have high availability, for example, there are needs to adopt a configuration (so-called an HA configuration) where operation can be continued even if one of the storage subsystems goes down. In that case, the LDEVs are duplicated (mirrored) in two physical storage subsystems constituting the virtual storage subsystem, and the duplicated LDEVs are provided to the host. However, if multiple volumes having the same contents are recognized by the host, the operation of the system become complicated, so that it is preferable to run a software (so-called an alternate path software) which hides the existence of two duplicated volumes and provides a single volume in the superior application program.

The alternate path software identifies whether multiple volumes are different or identical based on the information such as the identification numbers and the like of the volumes acquired from the storage subsystem. Therefore, under the HA configuration, even if one of the storage subsystems goes down, operation can be continued by assigning the same LDEV # to the duplicated volumes to make the host recognize that the duplicated volumes are an identical volume. However, in that case, if both volumes are recognized as identical volumes from the host during the process of duplicating the two volumes, that is, during copying of data from a primary volume to a secondary volume, the contents stored in the primary volume and the secondary volume differ, so that data consistency cannot be maintained.

One method for overcoming such problem is to not show the secondary volume to the host (so that so-called path definition will not be performed) until the duplication processing is completed. However, according to such method, the administrator must perform a process to set up a pair relationship between the primary volume and the secondary volume, wait for all the data stored in the primary volume to be copied to the secondary volume, and then perform path definition only after the data contents of the primary volume and secondary volume become identical. Since it takes a long time to copy all the data in the primary volume to the secondary volume, the administrator must be restrained for a long time.

### Solution to Problem

According to the method for creating an HA configuration of the present invention, in a virtual storage composed of resources of a first storage subsystem and a second storage subsystem, the administrator of the virtual storage selects from the second storage a replication destination volume (second logical volume) of a first logical volume of the first storage subsystem that the administrator wishes to duplicate. At this time, the second logical volume can select only the volume that is not recognizable from the host as the replication destination. When data duplication is started between the first logical volume and the second logical volume, the second storage sets an identification number of the second logical volume to be the same as an identification number of the first logical volume notified from the first storage. Thereafter, at the point of time when duplication is completed, the second storage changes the setting of the second logical volume so that the second logical volume is recognized by the host.

### Advantageous Effects of Invention

In the present invention, upon constituting an HA configuration, the administrator does not have to wait for the duplication processing of the volumes to be completed, so that the load applied on the administrator related to creating the HA configuration can be reduced.

### BRIEF DESCRIPTION OF DRAWINGS

FIG. 1 is a configuration example of a storage system and storage subsystems.

FIG. 2 is an example of a V-BOX management table.

FIG. 3 is an example of a virtual LDEV management table.

FIG. 4 is an example of an LU management table.

FIG. 5 is an example of a pair management table.

FIG. 6 is a view illustrating the concept of a virtual storage and V-BOX.

FIG. 7 is a view illustrating the functions of an alternate path software.

FIG. 8 is a view illustrating the change of state of logical volumes.

FIG. 9 is a view illustrating the change of state of logical volumes.

### DESCRIPTION OF EMBODIMENTS

Now, the preferred embodiments of the present invention will be described with reference to the drawings.

### Embodiment 1

### (1) Configuration of Storage System

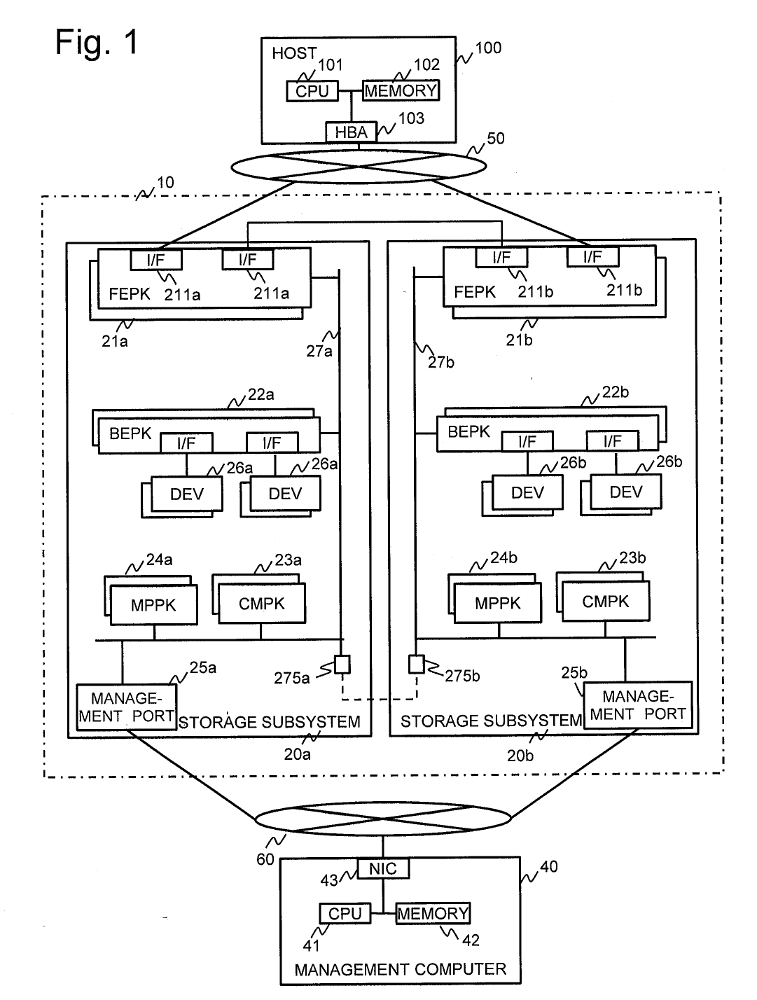

The configuration of a storage system 10 according to the preferred embodiment of the present invention will be described with reference to FIG. 1. The storage system 10 is composed, for example, of multiple (such as two) storage subsystems (20a and 20b). The configurations of the storage subsystems 20a and 20b are basically the same. In the following description, when it is not necessary to distinguish the storage subsystems 20a and 20b, the subsystem is referred to as “the storage subsystem 20”, without a suffix such as “a” or “b” attached after the number. Similarly, regarding the respective components within the storage subsystem 20, a suffix such as “a” or “b” is attached after the reference number of the component when it is necessary to distinguish the components within the storage subsystem 20a from the components within the storage subsystem 20b. When it is not necessary to distinguish the components within the storage subsystem 20a and the storage subsystem 20b, a suffix such as “a” or “b” will not be attached after the component reference number.

As shown in FIG. 1, the storage subsystem 20 is composed of an FEPK 21 (FEPK is an abbreviation of FrontEnd PacKage), an MPPK 24 (MPPK is an abbreviation of Micro Processor PacKage), a CMPK 23 (CMPK is an abbreviation of Cache Memory PacKage), a BEPK 22 (BEPK is an abbreviation of BackEnd PacKage), a management port 25, a storage device (noted as “DEV” in the drawing) 26, an internal network 27, and an internal network I/F 275. The internal network 27 is composed of high-speed transmission media such as a PCI Express, and mutually connects the FEPK 21, the MPPK 24, the CMPK 23, the BEPK 24, and the management port 25.

The MPPK 24 is a package board having multiple processors (MP) and local memories (LM). Each MP in the MPPK 24 can communicate with any one of the FEPK 21, the CMPK 23 and the BEPK 22, via the internal network 27. The FEPK 21 has multiple host I/Fs (I/Fs 211 in FIG. 1) for connecting to the SAN 50. Further, if the transmission medium constituting the SAN 50 is Fibre Channel (hereinafter also abbreviated as “FC”), the host I/F 211 is a Fibre Channel interface, and if the transmission medium constituting the SAN 50 is Ethernet (Registered Trademark), it is an Ethernet interface. Further, the host I/F (I/F 211, 212) has a unique identifier (for example, if the host I/F is a fiber channel interface, a WWN (World Wide Name) or a port ID) recognized by the host 100 or the like (hereinafter, this identifier is referred to as a “physical identifier” or a “physical port ID”).

The BEPK 22 has multiple disk I/Fs 221 for connecting the storage devices 26. The BEPK 22 is connected via a cable to the storage devices 26 and to the internal network 27, and mediates the handing over of read or write-target data between the CMPK 23 and the storage device 26.

The CMPK 23 has a memory for data cache (hereinafter referred to as CM) and a memory for control information (hereinafter referred to as SM). Volatile memory such as DRAM (Dynamic Random Access Memory) is used as the memory for data cache and the memory for control information, but nonvolatile memory such as flash memory can also be used. Further, when volatile memory is used as the CMPK 23, in order to prevent the data in the CMPK 23 from being lost when power supply to the storage subsystem 20 stops due to power failure or the like, a battery can be provided to realize a configuration where the data in the CMPK 23 will not be lost. The memory for data cache temporarily stores (caches) the data to be written to the storage device 26, or temporarily stores (caches) the data read from the storage device 26. Information required for the processing performed by the storage subsystem 20, such as a V-BOX management information described later, is stored in the memory for control information (SM).

The MPPK 24 has multiple processors (hereinafter abbreviated as MP), a local memory (LM), and a bus connecting the same. The MP executes a control program to perform processes that the storage subsystem 20 must perform, such as the processing of I/O requests (such as a read request, a write request or the like) from the host 100, or the processing of management operation requests from a management computer 40. The LM stores a portion of the control information stored in the memory for control information.

The management port 25 is a port for transmitting an operation request from the management computer 40 to a control program of the storage subsystem executed by the MP.

The storage device 26 is a final storage device for storing write data from the host 1000, and as an example, HDD (Hard Disk Drive) is used. However, storage devices other than the HDD, such as SSD (Solid State Drive), can also be used. The storage subsystem 20 is configured, by the control program of the storage subsystem 20 executed by the MP, to create a logical storage area (logical volume) from the storage areas included in one or more storage devices 26, and to provide the logical volume to the host 100.

Multiple FEPKs 21, BEPKs 22, CMPKs 23, MPPKs 24 and storage devices 26 exist in the storage subsystem 10 to enhance the failure resistance. However, the present invention is effective even if the number of any one of these components is one.

The storage subsystem 20a and the storage subsystem 20b included in the storage system 10 according to the preferred embodiment of the present invention are configured that one of the respective host I/Fs (211) are mutually connected via a FC (Fibre Channel) cable. In another example, the storage subsystem 20a and the storage subsystem 20b are configured that the mutual internal networks 27 are connected via a transmission line (in the drawing, the dotted line between the internal network I/Fs 275a and 275b shows the transmission line) through the internal network I/Fs 275. Thereby, transmission of data and various control information among the storage subsystems 20 are enabled.

Next, we will describe the host 100 and the management computer 40 connected to the storage subsystem 10. The host 100 is a computing apparatus having a CPU 101, a memory 102, a host bus adapter (HBA) 103 and the like, and a personal computer, a work station or a mainframe is used as the computing apparatus. Further, in addition to the components illustrated in the drawing, it can be equipped with a storage device such as an HDD, or an input/output means such as a keyboard and a display.

The CPU 101 reads and writes data from/to the logical volume provided by the storage subsystem 20 by executing an operating system or an application program (not shown) stored in the memory 102. Further, an alternate path software is installed in the host 100. HBA 103 is an interface for connecting via the SAN 50 to the storage subsystem 20.

We will now describe the configuration of the management computer 40. The management computer 40 is a computer connected to the management port 25 of the storage subsystem 20 via a management network 60, and it is a computer used by the administrator of the storage system 10 to perform setting operation of the storage system 10. The management computer 40 is also a computing apparatus having a CPU 41, a memory 42, a network interface controller (NIC) 43 and the like, similar to the host 100. In addition to the elements illustrated in the drawing, it can be equipped with a storage device such as an HDD, and an input/output means such as a keyboard and a display. A management software is installed in the management computer 40, and the administrator of the storage system 10 can utilize the management software to perform setting operation of the storage system 10.

In the present embodiment, only an example where the setting of the storage system 10 is performed from the management computer 40 connected to the management network 60 is illustrated. However, the method in which the administrator of the storage system 10 or the user accessing the storage system 10 performs setting of the storage system 10 is not restricted to using the management computer 40 connected to the management network 60. For example, it is possible to connect a computer for management to the SAN 50, and to transmit a setting instruction via the SAN 50 to the storage system 10. Further, it is possible to adopt a configuration when a software for performing setting of the storage subsystem 10 installed in the host 100 and the setting instruction is transmitted from the host 100 to the storage system 10.

Next, we will describe the logical volume (also abbreviated as “volume”) that the storage subsystem 20 according to the preferred embodiment of the present invention provides to the host 100. As mentioned earlier, the storage subsystem 20 creates a logical storage area (logical volume) from a storage area having one or more storage devices 26, and provides logical volumes to the host 100. The storage subsystem 20 assigns a unique identifier within the storage subsystem 20 to the respective logical volumes for management. In the present specification, this identifier is referred to as logical volume number (also denoted as LDEV#).

When the host 100 performs access to the logical volume, it issues an access request (command). Generally, LDEV # is not used as the information for specifying a logical volume in an access request. Instead, access is performed by designating an identifier of a host I/F 211 of the storage subsystem 20 (hereinafter referred to as “port identifier”) and a logical unit number (LUN). When the host I/F 211 is a Fibre Channel interface, for example, WWN or port ID is used as the port identifier. Further, the logical volume provided to the host 100 is sometimes referred to as logical unit (LU).

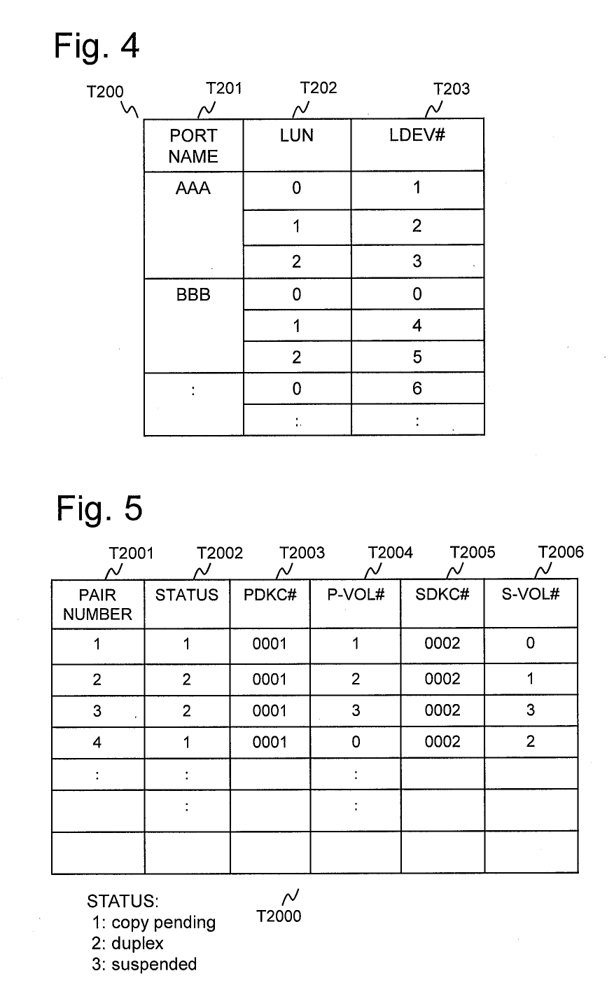

In the storage subsystem 20, the mapping between the LDEV # of a logical volume and the set of port identifier and LUN is managed. FIG. 4 illustrates one example of an LU management table T200 managing this mapping information. Information of the port identifier and LUN mapped to the logical volume specified by LDEV # (T203) are stored in port name T201 and LUN (T202). In the example of FIG. 4, information where the port name T201 is “AAA” and the LUN (T202) is “0” is mapped to a logical volume whose LDEV# (T203) of the logical volume is “1”. The mapping of the port identifier and the LUN to the logical volume is performed by the administrator issuing an instruction to the storage subsystem 20 using the management computer 40 and the like. This process of performing mapping is referred to as “path definition” or “LU path definition”.

When the storage subsystem 20 receives an access request from the host 100 designating “AAA” as port identifier and “0” as LUN, it refers to the LU management table T200 and converts the set of the port identifier and the LUN to the LDEV #. Thereafter, processing (read, write etc.) to the logical volume specified by the LDEV # is executed.

### (2) Virtual Storage

Next, we will describe a virtual storage provided by the storage system 10 according to the preferred embodiment of the present invention. The storage system 10 according to the preferred embodiment of the present invention defines one or multiple virtual storage subsystems (hereinafter, these are referred to as virtual storages) that differ from physical storage subsystems such as the storage subsystem 20a or the storage subsystem 20b and the like, and has a function so that virtual storages seem to exist in the SAN 50 from the host 100 and the management computer 40. Actually, a model name, a serial number (S/N) and the like of the storage subsystem are included in the information of respective logical volumes that the host can acquire by a SCSI INQUIRY command or the like, and when one virtual storage is composed, the host 100 (especially the alternate path software) recognizes that the logical volume within the storage subsystem 20a belonging the virtual storage and a specific logical volume within the storage subsystem 20b belonging to the relevant virtual storage are the same logical volume in an storage subsystem.

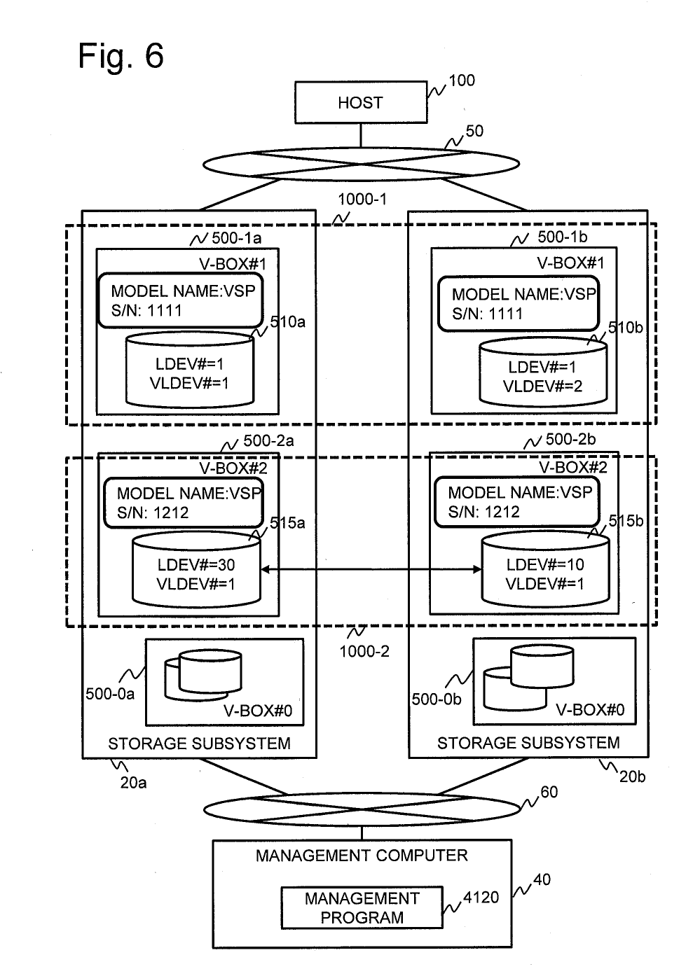

The concept of the virtual storage will be described with reference to FIG. 6. FIG. 6 shows a state where two virtual storages, virtual storages 1000-1 and 1000-2, are defined in the storage system 10. The virtual storage is defined by defining a management information called V-BOX within the storage subsystem 20. V-BOX is a management unit for managing information of resources such as the logical volumes within the storage subsystem 20. The actual contents of the management information will be described later. FIG. 6 illustrates as one configuration example a case where one logical volume exists in each V-BOX. In FIG. 6, the numbers shown after “V-BOX” (such as #0 and #1) are identifiers assigned to each V-BOX. This identifier is referred to as “VBOX ID”.

Further, V-BOX has a subsystem model name and a subsystem serial number (S/N) as attribute information. In FIG. 6, the V-BOX #1 within the storage subsystem 20a (500-1a) and the V-BOX #1 within the storage subsystem 20a (500-1b) both have the same subsystem model name (VSP) and subsystem serial number (S/N) (1111) as attribute information. Therefore, the alternate path software of the host 100 recognizes the logical volume 510a within the V-BOX #1 (500-1a) and the logical volume 510a within the V-BOX #1 (500-1b) as volumes existing within an identical subsystem. This is because, as mentioned earlier, the host 100 acquires the information of the respective logical volumes by the SCSI INQUIRY command and the like, and in the acquired information, the model names and the serial numbers (S/N) of the storage subsystems are the same. Therefore, a set of the V-BOX #1 (500-1a) and V-BOX #1 (500-1b) (a set of respective resources defined in the management information of the V-BOX #1 (500-1a) and V-BOX #1 (500-1b)) is recognized by the host 100 as a single storage subsystem (virtual storage 1000-1). Similarly, the V-BOX #2 (500-2a) and V-BOX #2 (500-2b) have the same subsystem model name (VSP) and subsystem serial number (1212), so that the set of these two V-BOXes (500-2a and 500-2b) is recognized as a single virtual storage 1000-2.

We will now describe the information of the logical volumes stored in the V-BOX. In general, in a storage subsystem, a unique identifier is assigned to each logical volume within the storage subsystem. In the present specification, this number is called a logical volume number (also referred to as LDEV#). For example, the logical volume 510a in the V-BOX #1 (500-1a) and the logical volume 510b in the V-BOX #2 (500-2a) of the storage subsystem 20a have different LDEV # assigned thereto (as shown in FIG. 6, the LDEV # of the logical volume 510a is 1 and the LDEV # of the logical volume 510b is 30).

In the storage subsystem 20 according to the preferred embodiment of the present invention, an identifier other than the LDEV # can be assigned to each logical volume. This identifier is called a virtual logical volume number (VLDEV #). LDEV # is a unique identifier within the storage subsystem (20a or 20b), but VLDEV # is a unique identifier within the virtual storage. Therefore, when multiple logical volumes belong to a virtual storage, the VLDEV # of each logical volume must all be different, excluding some exceptions (described later). However, the LDEV # of each logical volume can be the same as long as the logical volumes belong to a different storage subsystem 20.

For example, in the example of FIG. 6, one logical volume exists in the V-BOX #1 (500-1a) and V-BOX #1 (500-1b) in the virtual storage 1000-1, respectively, but the VLDEV # thereof are 1 and 2 (that is, different VLDEV # are assigned). However, the LDEV # of both logical volumes is 1. At the point of time when the logical volume is defined, the same number as the LDEV # is automatically assigned as the VLDEV #, but later, the user of the storage system 10 can change the number using the management computer 40 so that the number does not overlap with the number of other logical volumes. Further, the user of the storage system 10 can set a state where there is no VLDEV # (where the VLDEV # is set to a NULL (invalid value such as −1) state).

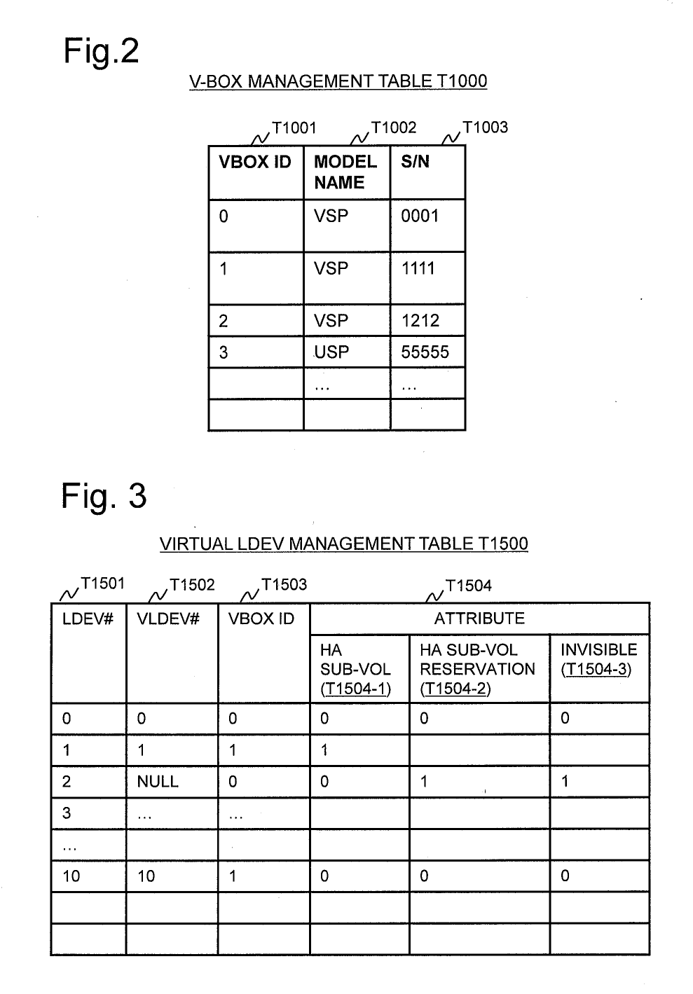

The management information used by the storage system 10 when defining the virtual storage will be described with reference to FIG. 2. FIG. 2 illustrates a configuration of a V-BOX management table T1000 stored in the storage subsystems 20a and 20b. The V-BOX management table T1000 is stored in the respective SMs of the storage subsystems 20a and 20b.

As mentioned earlier, the storage subsystem 20 defines a management information called V-BOX in the storage subsystem 20 to define the virtual storage. One row within the V-BOX management table T1000 of FIG. 2 corresponds to the information representing one V-BOX. The V-BOX is composed of a VBOX ID (T1001) which is an identifier of the V-BOX, a model name T1002 of the V-BOX, and a serial number (S/N) T1003 of the V-BOX.

Next, the configuration of a virtual LDEV management table will be described with reference to FIG. 3. A virtual LDEV management table T1500 is also stored in the SM.

The virtual LDEV management table T1500 is composed of the following entries: LDEV # (T1501), VLDEV # (T1502), VBOX ID (T1503), and attribute (T1504). An identification number of the logical volume belonging to the V-BOX (called LDEV #) is stored in the LDEV # (T1501). A virtual logical volume number assigned to the logical volume specified by the LDEV # (T1501) (VLDEV #) is stored in the VLDEV # (T1502). An identifier of the V-BOX to which the logical volume specified by the LDEV# (T1501) belongs (VBOX ID (T1001) managed by the V-BOX management table T1000) is stored in the VBOX ID (T1503).

The attribute information assigned to the relevant logical volume is stored in the attribute (T1504). The attributes assigned to the logical volume and related to the description of the present invention are “HA Sub-VOL” (T1504-1), “HA Sub-VOL Reservation” (T1504-2) and “Invisible” (T1504-3). When an attribute of “HA Sub-VOL” is assigned to the logical volume specified by the LDEV# (T1501), “1” is stored in the entry of the “HA Sub-VOL” (T1504-1) of the attribute (T1503) field. When an attribute of “HA Sub-VOL reservation” is assigned to the logical volume specified by the LDEV # (T1501), “1” is stored in the entry of “HA Sub-VOL reservation” (T1504-2) of the attribute (T1503) field. Further, when an “Invisible” attribute is assigned to the logical volume specified by the LDEV # (T1501), “1” is stored in the entry of “Invisible” (T1504-3) of the attribute (T1503) field. The meanings of the respective attributes will be described later. Further, attributes other than the attributes described above can be included in the attribute assigned to the logical volume.

The information on the logical volume belonging to the V-BOX defined within the storage subsystem 20a is stored in the virtual LDEV management table T1500 in the storage subsystem 20a. On the other hand, the information on the logical volume belonging to the V-BOX defined within the storage subsystem 20b is stored in the virtual LDEV management table T1500 in the storage subsystem 20b.

We will illustrate one example of a case where the storage subsystem 20 receives a request (such as an INQUIRY command) to acquire information on the logical volume from the host 100. In an INQUIRY command, a port identifier and a LUN are used as information for specifying the logical volume, so that when the storage subsystem 20 receives an INQUIRY command, it first refers to the LU management table T200, and changes the set of port identifier and LUN designated by the INQUIRY command to the LDEV # (T203). Thereafter, it refers to the virtual LDEV management table T1500, and specifies the VLDEV # (T1502) and the VBOX ID (T1503) corresponding to the LDEV# (T1501). Next, it specifies the model name (T1002) and S/N (T1003) corresponding to the VBOX ID (T1503) specified earlier from the V-BOX management table T1000. Then, the storage subsystem 20 returns the V-BOX model name (T1002), the S/N (T1003) and the VLDEV# (T1502), respectively, as the model name, serial number (S/N) and volume number of the storage subsystem included in the response information corresponding to the INQUIRY command.

### (3) HA Configuration of Storage System

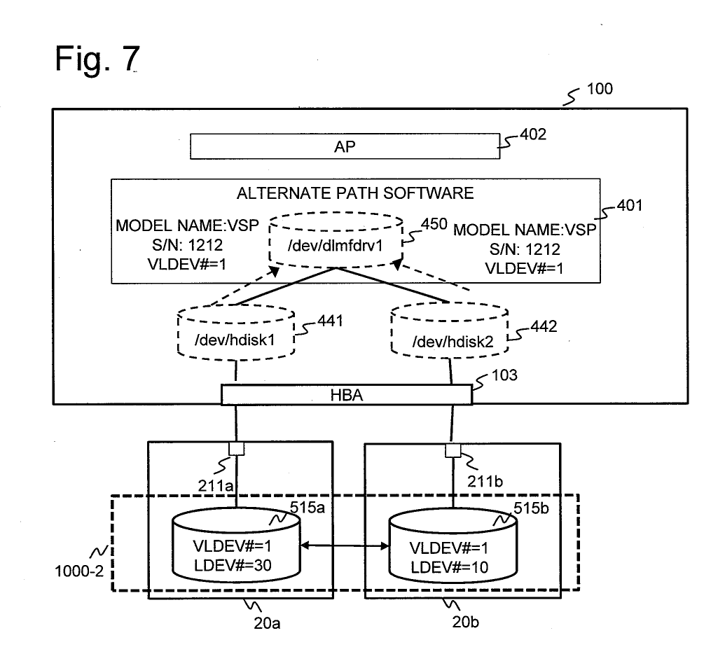

According to the storage system 10 of the preferred embodiment of the present invention, a configuration where the volumes and paths are duplicated can be adopted to enable operation to be continued even during failure of the storage subsystem 20 or the failure of the path between the host 100 and the storage system 10. This configuration is called High Availability configuration (hereinafter abbreviated as HA configuration). The HA configuration will be described with reference to FIG. 7.

In FIG. 7, the virtual storage 1000-2 has a subsystem model name of “VSP” and a subsystem serial number of “1212”, which are the same as the virtual storage 1002-1 illustrated in FIG. 6 (that is, a set of V-BOX 500-2a and V-BOX 500-2b). The respective volumes 515a and 515b in the storage subsystems 20a and 20b belong to the virtual storage 1000-2. Further, data stored in the volume is duplicated in volumes 515a and 515b by a volume mirroring function of the storage subsystem 20. When the host 100 writes data into the volume 515a by issuing a write command, the replica of the data written to the volume 515a is reflected in the volume 515b by the volume mirroring function.

The volume mirroring function will be described here. The volume mirroring function is a function of creating a replica (mirror copy) of the data in the logical volume of the storage subsystem 20a to the logical volume of the storage subsystem 20b. In the present specification, the logical volume of the storage subsystem 20a as the replication source is called a primary volume (P-VOL), and the logical volume of the storage subsystem 20b as the replication destination of the data in the P-VOL is called a secondary volume (S-VOL). Further the S-VOL storing the replicated data of the P-VOL is called a “volume in pair relationship” with the P-VOL (in contrast, the P-VOL storing the replication source data of the S-VOL is also called a volume in pair relationship with the relevant S-VOL). A set of the P-VOL and the S-VOL storing the replicated data of the relevant P-VOL is called a “pair” or a “pair volume”. Further, the operation that the user of the storage system 10 (the administrator, or the user using the logical volume from the host 100) instructs the storage system 10 to set the volumes of the LDEV of the storage subsystem 20a (P-VOL) and the LDEV (S-VOL) of the storage subsystem 20b to be in pair relationship using the volume mirroring function is called “pair creation”. In contrast, the operation for cancelling the relationship of volumes in pair relationship (so that the data in the P-VOL will not be replicated to the S-VOL) is called “pair cancellation”.

FIG. 5 illustrates a configuration of a pair management table T2000. This table is stored in the SM of both the storage subsystem 20a and the storage subsystem 20b. In the storage subsystem 20, each pair has an identifier assigned thereto for management, and this identifier is called a pair number (T2001). The pair management table T2000 manages information of the P-VOL and the S-VOL constituting each pair (a PDKC # (T2003) which is an identification number capable of specifying the storage subsystem to which the P-VOL belongs, a P-VOL # (T2004) which is the LDEV # of the P-VOL, an SDKC # (T2005) which is an identification number capable of specifying the storage subsystem to which the S-VOL belongs, and an S-VOL # (T2006) which is the LDEV # of the S-VOL). A serial number of the storage subsystem 20a and a serial number of the storage subsystem 20b are respectively stored in the PDKC # (T2003) and the SDKC # (T2005).

When the user of the storage system 10 uses the volume mirroring function to perform pair creation, the management software of the management computer 40 is used to issue a “pair creation” command designating the LDEV # of the P-VOL and the serial number of the storage subsystem to which the P-VOL belongs, and the LDEV # of the S-VOL and the serial number of the storage subsystem to which the S-VOL belongs, to the storage subsystem 20a. Thereby, the PDKC # (T2003), the P-VOL # (T2004), the SDKC # (T2005) and the S-VOL # (T2006) are registered in the pair management table T2000 of the storage subsystem 20a. These contents are also reflected from the storage subsystem 20a to the pair management table T2000 stored in the storage subsystem 20b. Then, operation to copy data from the P-VOL to the S-VOL is started.

Information representing the state of each pair (whether copy is ongoing or not, etc.) is stored in a status (T2002) field of the storage pair management table T2000. The state where not all the contents of the P-VOL are reflected in the S-VOL, such as immediately after issuing the pair creation command, is called “copy pending” state, and during this state, “1” is stored in the status (T2002) field. The state where all the contents of the P-VOL are reflected in the S-VOL is called “duplex” state, and during this state, “2” is stored in the status (T2002) field.

Further, the state where not all the contents of the P-VOL can be replicated in the S-VOL due to causes such as failure is called “suspended” state, and in that state, “3” is stored in the status (T2002) field. Further, the state where the pair state has been cancelled is called “simplex” state. The timing at which the pair status is set to “suspended” state is not restricted to the case where failure has occurred, and the user of the storage system 10 can set the pair status to “suspended” state manually by issuing an instruction to stop the copying operation through the management computer 40.

We will now return to the description of the HA configuration. The operating system of the host 100 recognizes each of the respective volumes 515a and 515b. That is, it recognizes that two volumes exist in the virtual storage, and device files corresponding to the respective volumes 515a and 515b (such as device files named/dev/hdisk1, /dev/hdisk2 and the like) are created. However in reality, since the contents of the two volumes 515a and 515b are the same, it is desirable that the two volumes are substantially handled as a single volume, and when failure occurs to the storage subsystem 20a or to the path between the host 100 and the storage subsystem 20a, the host 100 should preferably operate to access the volume 515b. Alternate path software 401 is a software for realizing this operation.

The alternate path software 401 hides the device files created to correspond to the respective volumes 515a and 515b, and shows a single virtual device file (such as/dev/dlmfdrv1 and the like) to a superior program such as an AP 402 and the like, so that the superior program can access the virtual device file. When the superior program designates a virtual device file and issues an access request thereto, the alternate path software 422 automatically converts the access to one of the multiple hidden device files (/dev/hdisk1, /dev/hdisk2 and so on). Further, when it becomes impossible to access volume 515a due to a failure of the storage subsystem 20a, it automatically performs access to volume 515b.

However, the alternate path software 401 performs the operation described above only when the alternate path software 401 recognizes that the respective volumes 515a and 515b are identical volumes. The alternate path software 401 uses a SCSI INQUIRY command and the like to acquire information of the respective logical volumes to identify whether the respective volumes are identical or not, and compares the model name, the serial number and the volume number of the storage subsystems included in the information.

As mentioned earlier, when the storage subsystem 20 receives a request to acquire information on the logical volume (such as the INQUIRY command), at least the model name (T1002) and the S/N (T1003) set in the V-BOX management table T1000 are returned as information on the storage subsystem to which the logical volume belongs. Therefore, when the alternate path software 401 issues an INQUIRY command to acquire information on the volume 515a and an INQUIRY command to acquire information on the volume 515b, the storage subsystems 20a and 20b each return the same storage subsystem model name and serial number to the host 100. Further, the subsystems return the VLDEV # as the volume number. If the virtual storage adopts the HA configuration, that is, when the two volumes are set to duplex state using the volume mirroring function, the VLDEV # of the two volumes can be an identical number. Thereby, it becomes possible to have the alternate path software 401 recognize that the two volumes 515a and 515b are identical.

However, the contents of the two volumes 515a and 515b are not identical from the beginning, and the contents of the two volumes differ before all the data stored in the volume 515a are replicated in the volume 515b by the volume mirroring function. If the alternate path software 401 recognizes that the two volumes 515a and 515b are identical in the state where the contents of the two volumes differ, the contents of the data being accessed will differ depending on which volume (515a or 515b) the alternate path software 401 accesses. In order to prevent such problem from occurring, the storage system 10 according to the preferred embodiment of the present invention has a function to change the state in which the volumes are provided to the host 100 according to the copy state of the logical volumes.

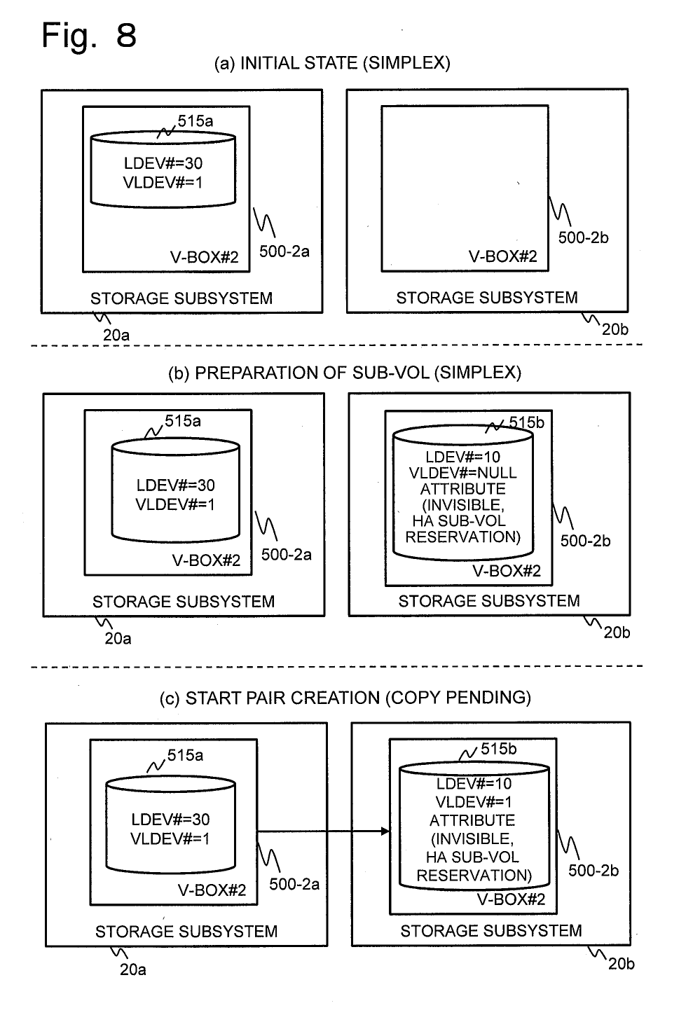

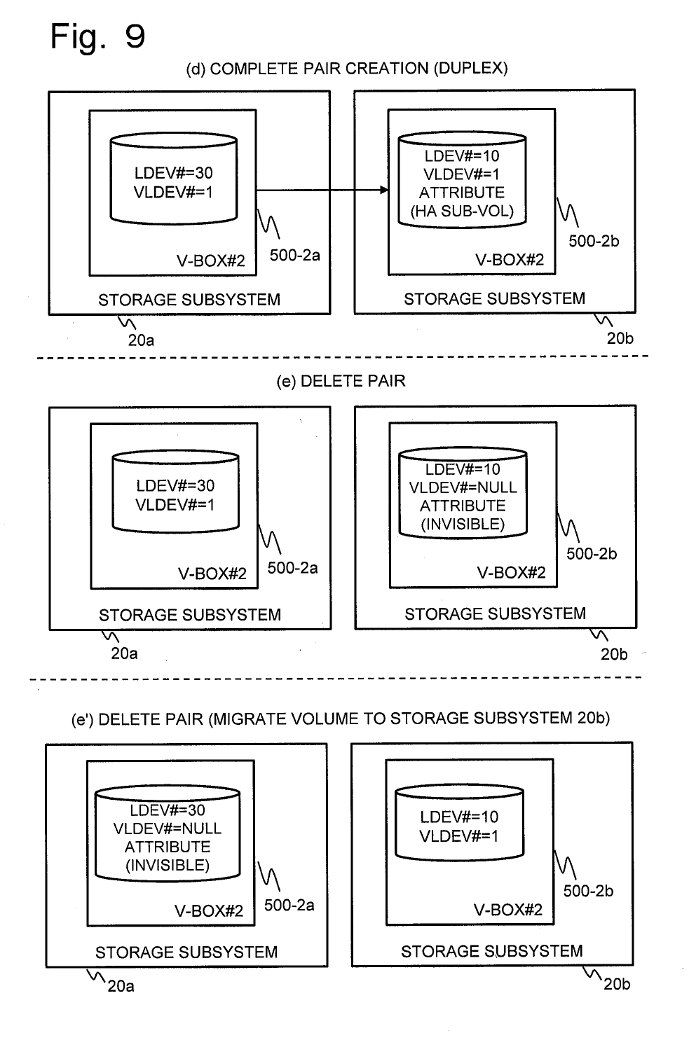

The flow of the operation will be described with reference to FIGS. 8 and 9. In FIGS. 8 and 9, an example is illustrated where the storage subsystem 20b is introduced to an environment where only the storage subsystem 20a is formed with a virtual storage, so as to create the HA configuration with the storage subsystems 20a and 20b.

In state (a) (initial state), a V-BOX #2 (500-2a) exists within the storage subsystem 20a. Then, the storage subsystem 20b is introduced, and each host I/F (211) of the storage subsystems 20a and 20b is connected mutually, as shown in FIG. 1 (in FIGS. 8 and 9, the transmission line connecting the storage subsystem 20a and 20b are not shown). The model name and S/N of the V-BOX #2 (500-2a) is set to “VSP” and “1212”.

Next, a V-BOX is created in the storage subsystem 20b, and the LDEV is made to belong to the created V-BOX (state (b)). The V-BOX created here has the same model name and S/N as the V-BOX #2 (500-2a) existing in the storage subsystem 20a.

This process is executed by the user of the storage system 10b issuing an instruction to the storage subsystem 20b using the management computer. As a result of this process, a V-BOX having 1 as the VBOX ID (T1001), “VSP” as the model name (T1002) and “1212” as the S/N (T1003) (which are the same as the model name and S/N of the V-BOX #2 (500-2a) of the storage subsystem 20a) is registered in the V-BOX management table T1000 of the storage subsystem 20b.

Hereinafter, the V-BOX #2 created in the storage subsystem 20b is denoted as V-BOX #2 (500-2b). Immediately after the V-BOX #2 (500-2b) is created, no volume exists within the V-BOX #2 (500-2b).

Next, a volume to be placed into the V-BOX #2 (500-2b) is prepared. A volume having belonged to another V-BOX (for example, V-BOX #0) within the storage subsystem 20b is used as this volume.

An example is illustrated where a volume having belonged to V-BOX #0 (having an LDEV #10) is used as the volume. In that case, at first, an operation is performed to the logical volume having LDEV #10 to set the VLDEV # to NULL and the attribute to “Invisible”.

This process is also performed by the user of the storage subsystem 10b using a management computer and issuing an instruction to the storage subsystem 20b. As a result of this process, in the row where the LDEV # (T1501) is “10” in the virtual LDEV management table T1500 of the storage subsystem 20b, NULL is stored in the VLDEV # (T1502) and 1 is stored in the attribute (Invisible (T1504-3)).

Thereafter, a process to move (register) the relevant volume to the V-BOX #2 (500-2b) is performed. This process is also performed by the user using the management computer and issuing an instruction to the storage subsystem 20b. When the user issues an instruction to move (register) the volume, an instruction to set the attribute [HA Sub-VOL reservation] to the volume is also performed at the same time. As a result of the process, in the row where the LDEV # (T1501) is “10” in the virtual LDEV management table T1500, “1” is registered in the VBOX ID (T1503). Further, the attribute of the logical volume is set to [HA Sub-VOL reservation] (attribute [HA Sub-VOL reservation] (T1504-2) is set to 1 in the relevant row of the virtual LDEV management table T1500).

When the attribute [HA Sub-VOL reservation] of the logical volume is set to “1”, the logical volume is reserved to be used as an S-VOL (a replication destination volume of a certain logical volume). In other words, the storage subsystem suppresses the relevant logical volume from being used for other purposes. In order to prevent the relevant logical volume from being used for other purposes, for example, requests other than a pair creation command can be set to be unaccepted until the relevant logical volume is started to be operated as an S-VOL by receiving the pair creation command from the host 100. In this state, the logical volumes 515a and 515b are in a simplex state since pair creation is not yet performed.

At this point of time, the user of the storage system 10 executes a so-called path definition, where the port identifier of the storage subsystem 20 and the LUN are mapped to the volumes 515a and 515b.

Next, in state (c), a process to replicate the contents of the logical volume 515a to the logical volume 515b is started using the volume mirroring function. The user of the storage system 1 uses the management computer to issue a pair creation instruction to the storage subsystem 20a to replicate the contents of volume whose LDEV # is 30 in the storage subsystem 20a to the volume whose LDEV # is 10 in the storage subsystem 20b, based on which the storage subsystem 20a starts a process to replicate the contents of the logical volume 515a to the logical volume 515b.

During the pair creation instruction, the user designates the serial number of the storage subsystem 20a and the LDEV # (30) of the logical volume 515a as the P-VOL information, and also designates the serial number of the storage subsystem 20b and the LDEV # (10) of the logical volume 515b as the S-VOL information.

In the storage subsystem 20a, when a pair creation instruction is received, it confirms whether pair creation is possible or not. For example, it confirms whether pair creation of the volumes designated by the pair creation instruction is possible or not, such as whether the size of the P-VOL and S-VOL are the same or not. Further, when the attribute [HA Sub-VOL reservation] of the S-VOL is set (to 1), if the model number and S/N of the V-BOX to which the P-VOL belongs differ from the model number and S/N of the V-BOX to which the S-VOL belongs designated by the pair creation instruction, the storage subsystem 20a rejects the pair creation instruction. Further, the storage subsystem 20a can be set to reject pair creation when the VLDEV # is not NULL (some VLDEV # is assigned). If pair creation is possible, the information of volumes 515a and 515b which are pair volumes is stored in the pair management table T2000, and further, “1” (copy pending) is stored in the state (T2002). Moreover, the information registered in the pair management table T2000 of the storage subsystem 20a is also reflected in the storage subsystem 20b. Thereby, the pair status of volumes 515a and 515b is set to “copy pending” state.

At this time, the storage subsystem 20a notifies the VLDEV # (1) of the P-VOL to the storage subsystem 20b. Regarding the volume whose LDEV # (T1501) is 10 in the virtual LDEV management table T1500, the storage subsystem 20b stores “1” in the VLDEV# (T1502), and sets the attribute [HA Sub-VOL reservation] (T1504-2) to “0” and the attribute [HA Sub-VOL] (T1504-1) to “1”. By having “1” stored in the VLDEV# (T1502), the VLDEV # of the volume 515b becomes the same as the VLDEV # of the volume 515a. However, the attribute [Invisible] of volume 515b (T1504-3) is set to “1”, so at this point of time, the volume 515b is not recognized from the host 100.

When the storage subsystem 20 receives a command regarding the logical volume whose attribute [Invisible] (T1504) is “1”, it returns a response stating that the relevant logical volume does not exist. For example, when it receives a SCSI REPORT LUNS command, a logical volume whose attribute [Invisible] (T1504) is “1” is not included in the response information to the REPORT LUNS command. When a SCSI INQUIRY command is received, a response information storing 0x1F (Unknown device type) in the PERIPHERAL DEVICE TYPE filed included in the response is returned.

When all the contents of the volume 515a are copied to the volume 515b, the pair status of the volumes 515a and 515b is set to “duplex” state (FIG. 9 (d)). In this state, the contents of the volumes 515a and 515b are the same, so that the volume 515b can be set to a state capable of being recognized by the host 100. Therefore, at the timing when the pair status of the volumes 515a and 515b becomes a “duplex” state, the storage subsystem 20b changes the attribute [Invisible] (T1504) of the volume 515b to “0”. In this state, when an INQUIRY command is received from the host 100 to the volume 515b, it returns the VLDEV # of the volume 515b and the subsystem model name and serial number of the V-BOX #2 (500-2b). Similarly, when an INQUIRY command is issued from the host 100 to the volume 515a, the storage subsystem 20a returns the VLDEV # of the volume 515a and the subsystem model name and serial number of the V-BOX #2 (500-2a). Since the VLDEV # and the subsystem model name and serial number of V-BOX #1 (500-2a, 500-2b) of volumes 515a and 515b are the same, the alternate path software 401 of the host 100 recognizes that the volume 515b is an identical volume as the volume 515a. Thus, the creation of the HA configuration is completed.

In contrast, if it is necessary to provide a state where the HA configuration is cancelled from the state shown in FIG. 9 (d), the user of the storage system 10 issues a command to cancel the pair state of the volumes 515a and 515b. Thereby, the pair state of the volumes 515a and 515b is cancelled (enters a simplex state), and duplication of data will not be performed between the volumes 515a and 515b. Furthermore, the VLDEV # (T1502) of the volume 515b is set to NULL, the attribute [HA Sub-VOL] (T1504-1) is set to “0” and the attribute [Invisible] (T1504-3) is set to “1”. Thereby, the alternate path software 401 of the host 100 recognizes that the volume 515b does not exist, and it will not issue I/O requests to the volume 515b.

As another embodiment, it is possible to leave the volume 515b to be recognized by the host 100, and to have the volume 515a to not be recognized by the host 100. In that case, the user of the storage system 10 issues an instruction to change the volume 515b to be the P-VOL and the volume 515a to be the S-VOL. Thus, the attribute of the volume 515a [HA Sub-VOL] (T1504-1) is set to “1” and the attribute of the volume 515b [HA Sub-VOL] (T1504-1) is set to “0”. Further, the direction of replication of data is changed to be replicated from the volume 515b to the volume 515a.

Thereafter, by issuing a command to cancel the pair state of the volumes 515a and 515b as mentioned earlier, the pair state of the volumes 515a and 515b is cancelled (duplication will not be performed), and the LDEV # (T1502) of the volume 515a is set to NULL, the attribute [HA Sub-VOL] (T1504-1) will be set to “0” and the attribute [Invisible] (T1504-3) is updated to “1”. Thereby, the alternate path software 401 of the host 100 having issued the I/O request to the volume 515a will recognize that the volume 515a no longer exists, and will not issue I/O requests to the volume 515a. Instead, it will issue I/O requests to the volume 515b.

By performing this operation, it becomes possible to migrate the data in the volume of the storage subsystem 20a (volume 515a) to (the volume 515b of) the storage subsystem 20b. Further, migration is performed to the volume 515b in a state where the same volume identification information (VLDEV #, model name and S/N of V-BOX and the like) as the information set to the volume of the storage subsystem 20a (volume 515a) is set thereto. Therefore, this method is effective when it is desirable to migrate volumes among storage subsystems transparently with respect to the host 100.

The above description has described the method for creating an HA configuration in a storage system according to the preferred embodiment of the present invention. In a storage system according to the preferred embodiment of the present invention, along with the transition of the pair status of the logical volumes from copy pending state to duplex state, the state of the storage system where the sub-volume is not recognized from the host is transited automatically to the state where it is recognizable from the host. Therefore, when the user performs an operation to create HA configuration, by outputting a pair creation instruction after performing path definition of the logical volume, the state is transited automatically to the state where the sub-volume is recognized by the host when the contents of the main volume and the sub-volume become identical. Some of the alternate path software operating in the host enables to set an alternate path automatically at the point of time when volumes determined as identical volumes are recognized. Therefore, by adopting such alternate path software to the storage system according to the preferred embodiment of the present invention, the user can enjoy the merit of having the setting of the alternate path software automatically completed together with the completion of copying of data among volumes, by simply transmitting a pair creation instruction.

### REFERENCE SIGNS LIST

10: Virtual storage, 20: Storage subsystem, 40: Management computer, 50: Storage area network, 60: Management network, 100: Host computer

1. A storage system comprising a first storage subsystem and a second storage subsystem, each comprising multiple volumes and connected to a host computer,
wherein the first storage subsystem and the second storage subsystem respectively comprise multiple volumes,
in a state where the storage system is set to have a configuration where a copy of data in a first volume of the first storage subsystem is stored into a second volume of the second storage subsystem, and the host computer is made to recognize that the first volume and the second volume are identical volumes,
one of the multiple volumes of the second storage that is in a state not recognized by the host computer is set as the second volume,
in a case where data replication from the first volume to the second volume is started, an identification number of the first volume is transmitted from the first storage subsystem to the second storage subsystem,
the second storage subsystem assigns the identification number received from the first storage subsystem to the second volume, and
at a point of time when data replication from the first volume to the second volume is completed, the state of the second volume is changed so that the second volume can be recognized from the host computer.

2. The storage system according to claim 1,
wherein the first storage subsystem assigns a volume number, which is a unique number within the first storage subsystem, and a virtual volume number, to the volume that belongs to the first storage subsystem,
the second storage subsystem assigns a volume number, which is a unique number within the second storage subsystem, and a virtual volume number, to the volume that belongs to the second storage subsystem, and
in a case where data replication from the first volume to the second volume is started, the first storage subsystem transmits the virtual volume number assigned to the first volume as the identification number to the second storage subsystem, and the second storage subsystem assigns the virtual volume number having been received from the first storage subsystem to the second volume for management.

3. The storage system according to claim 2,
wherein the storage system assigns one or more attributes to the volume for management,
in a case where an invisible attribute, which is one of multiple attributes, is set to the volume, the storage system sets the volume to a state not recognizable from the host computer, and
in a case where the invisible attribute is not set to the volume, the storage system sets the volume to a state recognizable from the host computer.

4. The storage system according to claim 3,
wherein before data replication from the first volume to the second volume is completed, the invisible attribute is set to the second volume, and
at the point of time when data replication from the first volume to the second volume is completed, the storage system changes the second volume to a state where the invisible attribute is not set.

5. The storage system according to claim 4,
wherein after data replication from the first volume to the second volume has been completed, in a state where the second storage subsystem receives a volume information inquiry command from the host computer to the second volume, the second storage subsystem returns a volume information including a virtual volume number of the second volume.

6. The storage system according to claim 5,
wherein the first storage subsystem and the second storage subsystem are respectively capable of defining a V-BOX to which one or more volumes belong,
the V-BOX has a serial number of the virtual storage set thereto, and
in a state where the volume belongs to the V-BOX, if a volume information inquiry command regarding the volume is received from the host computer, a serial number that the V-BOX has is returned in addition to the virtual volume number set to the volume.

7. The storage system according to claim 6,
wherein in a state where a sub-Vol reservation attribute, which is one of the multiple attributes, is set to the volume, the volume is configured so that the volume is not used for purposes other than the purpose of a replication destination volume, and
in a state where the sub-Vol reservation attribute is set to the second volume, the data replication will not be performed if a serial number of a first V-BOX to which the first volume belongs does not correspond with a serial number of a second V-BOX to which the second volume belongs.

8. The storage system according to claim 4,
wherein after data replication from the first volume to the second volume is completed, in a state where the storage system receives an instruction to switch roles of the first volume and the second volume,
the storage system changes a configuration of the storage system such that replication of data of a second volume of the second storage subsystem is stored in a first volume of the first storage subsystem,
in a state where an instruction to cancel the configuration is received, the storage system ends the process to store a replication of data of the second volume to the first volume, and
the storage subsystem sets the invisible attribute to the first volume.

9. A method for managing a storage system comprising a first storage subsystem and a second storage subsystem, each comprising multiple volumes and connected to a host computer,
wherein the first storage subsystem and the second storage subsystem respectively have multiple volumes,
in a state where the storage system is set to have a configuration such that a replication of data in a first volume of the first storage subsystem is stored in a second volume of the second storage subsystem, and the host computer is made to recognize that the first volume and the second volume are identical volumes, the method comprises:
1) setting one of the multiple volumes of the second storage to be in a state not recognized by the host computer, and selecting the volume set to the state not being recognized by the host computer as the second volume;
2) the first storage subsystem transmitting an identification number of the first volume to the second storage subsystem when starting data replication from the first volume to the second volume;
3) the second storage subsystem assigning the identification number received from the first storage subsystem to the second volume; and
4) at a point of time when data replication from the first volume to the second volume is completed, the second storage subsystem changing the state of the second volume such that the second volume is recognizable from the host computer.

10. The method for managing a storage system according to claim 9,
wherein the first storage subsystem assigns a volume number, which is a unique number within the first storage subsystem, and a virtual volume number, to the volume belonging to the first storage subsystem,
the second storage subsystem assigns a volume number, which is a unique number within the second storage subsystem, and a virtual volume number, to the volume belonging to the second storage subsystem,
the method comprising:
setting an invalid value as the virtual volume number of the second volume in the 1); and
causing the first storage subsystem to transmit the virtual volume number assigned to the first volume as the identification number to the second storage subsystem, and causing the second storage subsystem to assign the virtual volume number having been received from the first storage subsystem to the second volume for management in the 2).

11. The method for managing a storage system according to claim 10,
wherein the storage system assigns one or more attributes to the volume for management,
in a state where an invisible attribute, which is one of multiple attributes, is set to the volume, the storage system sets the volume to a state not being recognized from the host computer, and
in a state where the invisible attribute is not set to the volume, the storage system sets the volume to a state recognizable from the host computer.

12. The method for managing a storage system according to claim 11,
wherein before data replication from the first volume to the second volume is completed, the invisible attribute is set to the second volume, and
in the step 4, at the point of time when data replication from the first volume to the second volume is completed, the storage system changes the second volume to a state where the invisible attribute is not set.

13. The method for managing a storage system according to claim 12,
wherein after data replication from the first volume to the second volume is completed, in a state where the second storage subsystem receives a volume information inquiry command from the host computer to the second volume, the second storage subsystem returns a volume information of the second volume.

14. The method for managing a storage system according to claim 13,
wherein the first storage subsystem and the second storage subsystem are each capable of defining a V-BOX to which one or more volumes belong;
the V-BOX has a subsystem model name and a serial number of the virtual storage; and
in a state where the volume belongs to the V-BOX;
if a volume information inquiry command regarding the volume is received from the host computer, the storage subsystem returns the subsystem model name and the serial number that the V-BOX to which the volume belongs has, in addition to the virtual volume number.

15. The method for managing the storage system according to claim 14,
wherein in a state where a sub-Vol reservation attribute, which is one of the multiple attributes, is set to the volume, the volume is configured so that the volume is not used for purposes other than the purpose of a replication destination volume, and
in a state where the sub-Vol reservation attribute is set to the second volume, the data replication will not be performed if a subsystem model name and serial number of a first V-BOX to which the first volume belongs do not correspond with a subsystem model name and serial number of a second V-BOX to which the second volume belongs.
